(19) United States
(12) Patent Application Publication
(10) Pub. No.: US 2006/0165137 A1
(43) Pub. Date: Jul. 27, 2006

(54) Novel external cavity CW frequency doubling of semiconductor lasers to generate 300-600nm light

(76) Inventors: Alexander Kachanov, Synnyvale, CA (US); Boris Kharlamov, San Jose, CA (US); Sze Tan, Sunnyvale, CA (US); Barbara Paldus, Portola Valley, CA (US)

Correspondence Address: Herbert Burkard, 480 Oakmead Parkway, Sunnyvale, CA, 94085, US

(21) Appl. No.: 11/040,889

(22) Filed: Jan. 21, 2005

(51) Int. Cl. H01S 3/10; H01S 3/04

(52) U.S. Cl. 372/21; 372/22; 372/34; 372/36

(57) ABSTRACT

A novel control system for a simple and compact all-solid-state laser generating 300 nm to 600 nm nm light with continuously variable output power in the range from 1 mW to at least 120 mW. Single frequency radiation from an external cavity semiconductor laser is frequency doubled in a periodically poled MgO:LiNbO₃ waveguide. The laser maintains a high quality TEM₀₀ circular beam with M²<1.1 and very low noise of less than 0.06% over the entire range of output power. Less than 0.1% peak-to-peak output power variation is measured during prolonged operation. In one example, no degradation of the conversion efficiency is observed for operation at an output power of 70 mW and the laser has a small footprint of only 5×8 cm.

### FIELD OF THE INVENTION

This invention relates to a solid state laser which generates 300 nm to 600 nm (UV A &B and visible) light by frequency doubling using a periodically poled waveguide. The invention is particularly useful for generating 488nm (blue) light, which is widely used in medical diagnostic applications.

### BACKGROUND OF THE INVENTION

Compact, inexpensive and reliable sources of green, blue and violet light are required for various applications which include flow cytometry, gene sequencing, reprographics and semiconductor circuit manufacturing control. Gas lasers, such as HeNe, air cooled Ar⁺ and HeCd have been used in these areas for many years. Consequently numerous methods and measurement protocols, which are specific to the wavelengths emitted by such prior art lasers, have been developed. Gas lasers, however, have several undesirable features, namely they are bulky, inefficient, and require frequent replacement of the gas-discharge tubes. Recent developments in semiconductor lasers and nonlinear optics have the potential to replace gas lasers with solid state devices having a much smaller footprint, higher efficiency, longer lifetimes and reduced service requirements. However, such devices must also offer those properties that have been provided by gas lasers, namely high beam quality, pointing stability and reproducibility of the beam parameters (i.e. beam diameter, divergence, beam waist location). In addition, they have to match the popular gas laser wavelengths. Moreover, some applications would welcome lasers with output powers higher than 20 mW, and with tunable power. These combined requirements render many promising laser technologies, such as diode-pumped solid-state lasers, unsuitable for many applications, especially for those requiring green, blue or violet light of a specific wavelength.

External-cavity semiconductor laser technology, which first established itself in the telecommunications industry can produce devices which are candidates for replacing gas lasers, provided they are able to achieve the desired output power levels, and even more importantly, meet the beam quality requirements (E. H. Wahl, B. A. Richman, C. W. Rella, G. M. H. Knippels, and B. A. Paldus, “Optical performance comparison of argon-ion and solid-state cyan lasers,” Optics and Photonics News, pp. 36-42, November 2003). The direct frequency conversion of a semiconductor laser output in an external frequency-doubling section is perhaps the most straightforward method for achieving this goal, although the prospects for increasing the output power significantly higher levels may be limited.

As an example of an alternative configuration which would allow significant output power scaling, the generation of 130 mW of blue light using a pump platform and a non-linear element in an external ring enhancement cavity has recently been reported (G. M. H. Knippels, S. Koulikov, B. Kharlamov, G. Vacca, C. W. Rella, B. A. Richman, A. A. Kachanov, S. M. Tan, E. H. Wahl, H. Pham, and E. R. Crosson, “Moving solid state cyan lasers beyond 20 mw.,” Proceedings of the SPIE—The International Society for Optical Engineering 5332(1), pp. 175-179, 2004). This design, although useful, it is still technically more complex than that resulting from the direct wavelength doubling technique.

Nonlinear waveguides have been under extensive development by many groups since the early 1990's. Good results have been achieved, for example 17.3 mW of CW blue power at 426 nm was obtained with a 55 mW AlGaAs laser diode and a periodically poled MgO:LiNbO₃ proton-exchanged waveguide with a conversion efficiency of 31% (T. Sugita, K. Mizuuchi, Y. Kitaoka, and K. Yamamoto, “31%—efficient blue second—harmonic generation in a periodically poled MgO:LiNbO₃ ,” Optics Letters 24, pp. 1590-1592, Nov. 15 1999). However until recently, periodically poled waveguides have been mostly confined to laboratory use, because of multiple technological challenges. The problems include their rather limited lifetimes, the non-ideal mode overlap between the fundamental and the SHG modes due to relatively weak confinement of the guided mode, and a trade-off between the refractive index change and nonlinearity.

Some progress in manufacturing nonlinear waveguides was made in 2001 when a new method of manufacturing waveguides using ultra-precision machining combined with two-dimensional poling was announced (T. Kawaguchi, T. Yoshino, J. Kondo, A. Kondo, S. Yamaguchi, K. Noda, T. Nahagi, M. Imaeda, K. Mizuuchi, Y. Kitaoka, T. Sugita, and K. Yamamoto, “High-power blue/violet QPM-SHG laser using a new ridge-type waveguide,” Technical Digest of CLEO 2001 Conference, 6-11 May 2001 Baltimore CTul6, p. 141, May 2001). The structure was a thin 3 micrometer slab of MgO:LiNbO₃ glued to a LiNbO₃ substrate with an epoxy having low refractive index. The waveguide is formed by cutting a 5 micrometer wide ridge in the slab using a diamond saw. A very high index contrast confines both the pump mode and the second harmonic mode almost entirely within the waveguide, thus producing nearly perfect overlap between their electric fields. In this first attempt, they achieved 100 mW of second harmonic power at 412 nm with a Ti:Sapphire pump and 14 mW with a diode laser. More recently, more than 200 mW of blue power and 58% conversion efficiency were demonstrated using a diode-pumped Nd:YAG laser (M. Iwai, T. Yoshino, S. Yamaguchi, M. Imaeda, N. Pavel, I. Shoji, and T. Taira, “High-power blue generation from a periodically poled MgO:LiNbO₃ ridge-type waveguide by frequency doubling of a diode end-pumped Nd:Y₃Al₅O₁₂ laser,” Applied Physics Letters 83, pp. 3659-3661, Nov 3 2003). A demonstration of the potential of the new technology was the fabrication of a ridge waveguide with a poling period as short as 1.4 micrometers in order to obtain 22.4 mW of 340 nm radiation with only 81 mW of diode pump power (K. Mizuuchi, T. Sugita, K. Yamamoto, T. Kawaguchi, T. Yoshino, and M. Imaeda, “Efficient 340-nm light generation by a ridge-type waveguide in a first-order periodically poled MgO:LiNbO₃,” Optics Letters 28, pp. 1344-1346, Aug 1 2003).

The goal of our work was to achieve a laser capable of emitting greater than 100 mW of 300 nm-600 nm radiation with direct pumping of a waveguide using an external cavity diode laser. We have developed a laser with a nonlinear, periodically poled waveguide, and discovered its suitability for applications in which high beam quality, stability and low noise are all required. Although the invention will be primarily described and illustrated in the context of generating 488 nm radiation using a 976 nm pump laser (i.e., an electrically pumped gain chip which emits radiation at 976 nm), it is to be understood that the system of our invention is useful for generating 300 nm-600 nm radiation by the appropriate choice of the emission frequency of the pump laser (i.e., 600 nm to 1200 nm) and choice of a periodically poled frequency doubling crystal (wave guide). W. P. Risk, T. R. Gosnell, and A. V. Nurmikko, Cambridge University Press, 2003 ISBN 0 521 62318 9. We have found that particularly suitable waveguides can be fabricated from both congruent and non-congruent Lithium Niobate or Lithium Tantalate, especially when MgO doped, or from Potassium Titanyl Phosphate. The laser of the present invention is particularly suitable for generating light having a wavelength of 340 nm, 488 nm, 505 nm and 532 nm. The general technique of frequency doubling by second harmonic generation is known in the art and is described in numerous publications e.g., “Compact Blue-Green Lasers”, (stet).

### BRIEF DESCRIPTION OF THE DRAWINGS

FIG. 1a is a diagram showing the general optical layout of a laser in accordance with our invention. Infrared pump radiation from the electrically pumped gain chip (976 nm shown by way of example) is focused into the waveguide. In a preferred embodiment as shown, the blue output beam is preferably collimated and circularized by beam shaping optics or it can be fiber coupled. The 976 nm radiation is blocked by an additional filter. The frequency doubling section comprises the waveguide, beam shaping optics and 976 nm filter.

FIG. 1b is a diagram showing the arrangement of the gain chip and wave guide mounted on a single supporting optical bench whose temperature is controlled by it being in thermally conductive contact with a single thermoelectric cooler which is normally used in conjunction with some form of heat sink. I_{GC} and I_{TEC} denote the current to the gain chip and thermoelectric cooler, respectively. λ_{red} denotes the 976 nm output light from the gain chip and P_{blue} denotes the 488 nm output light from the waveguide

FIG. 2a shows the variation of output power with bench temperature over an approximately 2° C. range at a fixed wavelength for one embodiment of the laser of our invention.

FIG. 2b again shows the relationship of output power at 488 nm as a function of bench temperature at constant wavelength for a different laser from that shown in FIG. 2a but also in accordance with the present invention. The diagonal hatching indicates the preferred laser operating region.

FIG. 3 shows a simplified block diagram of the control loop used to maintain the bench temperature and laser output power at a specified value.

FIG. 4 shows the variation of output power and bench temperature with time for an extended time run.

FIG. 5 shows the variation of the measured output power during a sensor malfunction recovery period.

FIG. 6 illustrates the fact that variable output power is achievable by controlling the bench temperature. The overlay shows details of a single step with an expanded timebase.

FIG. 7 shows the output power variability for a number of higher output power levels (10 mW to 50 mW). The detector gain was the same for all these graphs.

FIG. 8 shows the output power variability for a number of lower output power levels (0 to 20 mW). The detector gain was increased over that used for the graphs in FIG. 7. The gains for the upper two graphs are the same, and likewise those for the two lower graphs are the same.

FIG. 9 illustrates the dependence of 488 nm power at the output of the waveguide on the injected 976 nm power. “*” denote experimental points and the solid line is a fit using eq. 7. Note the output power saturation caused by thermal rollover at the higher 976 nm powers.

FIG. 10 is a diagram showing beam shaping optics which can advantageously be used to enhance the beam quality of the frequency doubled light emitted from the waveguide

FIG. 11 illustrates the result of the output beam profile measurements when the beam is corrected using beam shaping optics as shown in FIG. 10. The graph shows beam size dependence on the distance from an external focusing lens in the x and y directions and the calculated M² values.

### DESCRIPTION OF THE INVENTION

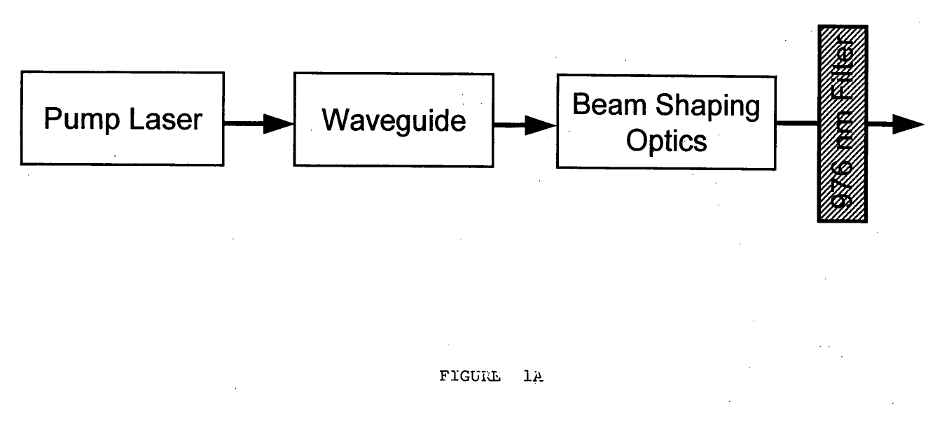

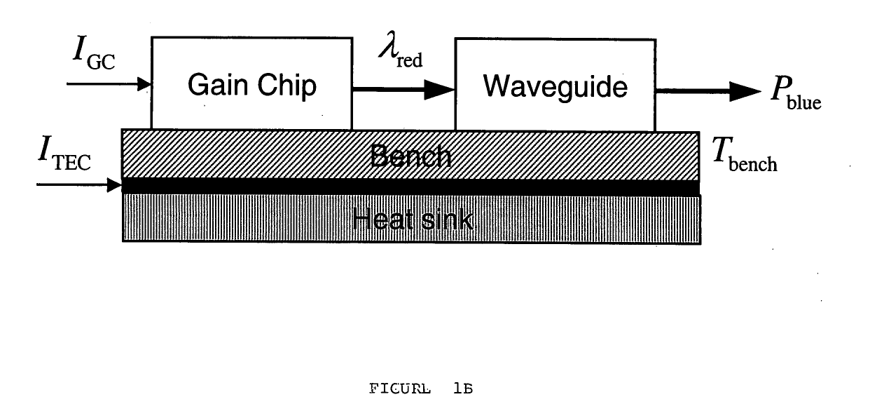

The optical layout of the laser is shown in FIGS. 1a and 1b. It comprises two building blocks—a pump section, which is preferably an external cavity single frequency semiconductor laser, and a frequency doubling section as shown in FIG. 1a which contains, for example, a periodically poled MgO:LiNbO₃ (Magnesium Oxide doped Lithium Niobate) ridge waveguide, (manufactured by NGK Insulators, Ltd), with associated focusing and beam shaping optics. The size of the waveguide is 3 by 5 micrometers, respectively in the vertical and horizontal directions and the length is 8.5 mm. The poling period was optimized to have a phase matching temperature of about 26° C. for a fundamental (pump ) wavelength of 976 nm.

The periodically poled ridge waveguide keeps both the fundamental and second harmonic waves confined in two dimensions within substantially the same area. This results in a very high conversion efficiency provided that the pump field is efficiently coupled into the fundamental mode of the waveguide. The rather small size of the fundamental mode imposes sub-micron tolerances on the alignment of the input beam, which is difficult to maintain with varying ambient conditions over long periods of time. Even mounting the waveguide on a thermo-electric cooler (TEC) can become a problem, since the small expansion or contraction associated with changes in the external temperature can be significant at the sub-micron level.

One aspect of our invention is to mount all the components of the frequency doubling section, including the waveguide, directly onto the same optical bench and thermo-electric cooler as the pump laser. The temperature of the waveguide is then defined by the temperature of the optical bench, which in turn is controlled by the laser TEC. Using a single TEC for both the laser and the waveguide gives maximum mechanical and thermal stability, and still delivers high performance despite the reduced number of the degrees of freedom.

Operation without independent control of the temperature of the pump laser and the temperature of the waveguide is practical because our pump laser, such as an external cavity diode laser(ECDL), has an internal current control loop that maintains single frequency operation at a constant predefined wavelength even though the laser bench temperature changes. The only effect of the change in the temperature of the bench is to vary the output power of the pump section. This advantageous control system is described in copending, commonly assigned U.S. patent application Ser. No. 10/409,879 filed Feb. 12, 2004 the teaching of which is incorporated herein by this reference. A substantially identical control system can be utilized in conjunction with a Distributed Feedback (DFB) or Distributed Bragg Reflector (DBR) pump laser which are also suitable for the practice of the current invention.

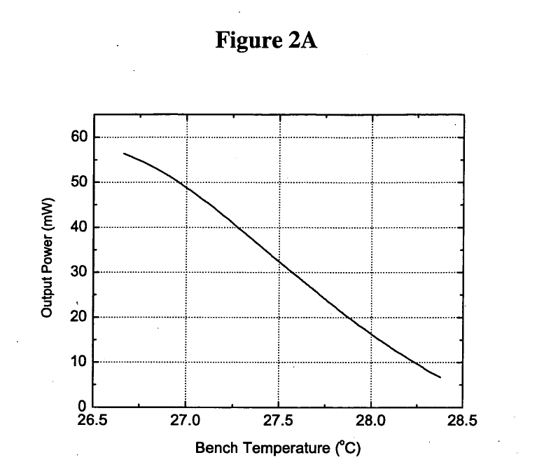

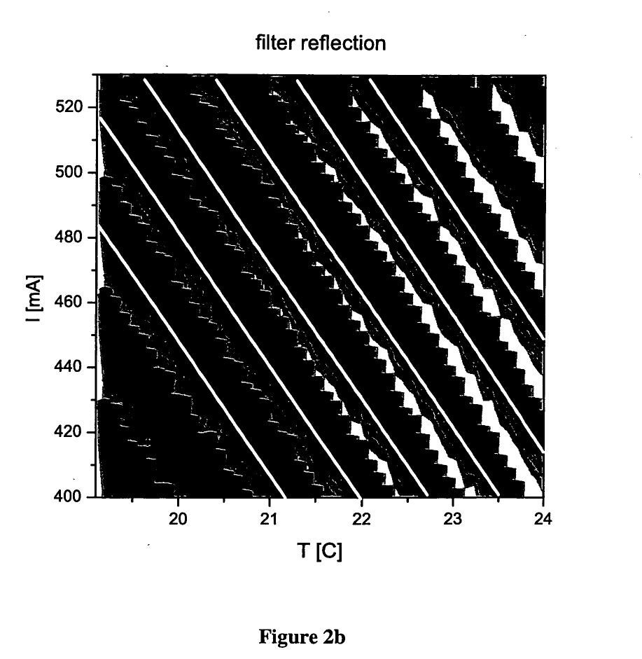

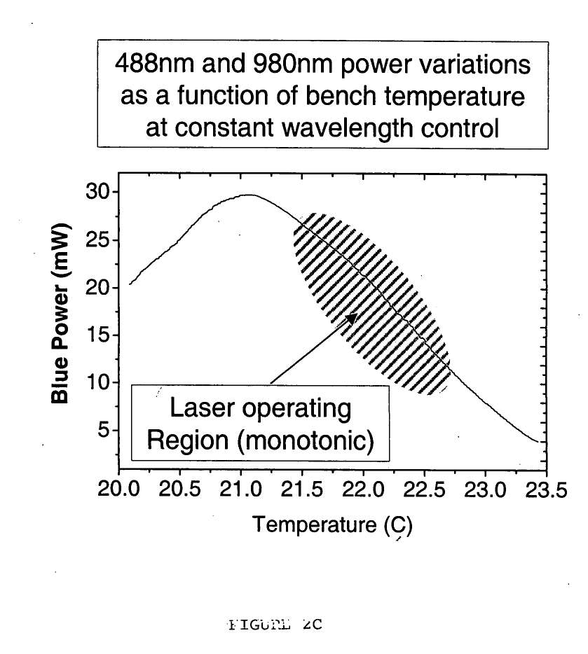

The blue output power of the laser depends on the pump power and the efficiency of second harmonic generation. At a fixed wavelength, second harmonic generation efficiency is a sensitive function of the waveguide temperature, since this affects the propagation speeds of the fundamental and second harmonic waves within the guide. The phase-matching condition for maximum efficiency is
ΔDk=2k_{f}+(2n+1)kₚ−kₛ=0 (1)

where k_{f} and kₛ are the effective propagation constants for the fundamental and second harmonic in the guide, n is an integer and 2π/kₚ is the poling period. As the mismatch |Δk| increases, the efficiency decreases by a factor of sin c² (ΔkL/2) where L is the interaction length within the waveguide and sin c(x)=sin(x)/x. As previously indicated, the pump laser and the waveguide are mounted on a single bench. Their temperature may be adjusted by varying the current passing through a thermo-electric cooler (TEC) mounted under the bench. Depending on the polarity of the current, the bench may be heated or cooled. At fixed operating wavelength, the combined effects of the variation in the pump power and the second harmonic conversion efficiency lead to a dependence of the output power on the bench temperature as shown in FIGS. 2a and 2c. ( see comments at Figure description) The blue output power reaches its maximum at approximately 26° C. when using these two example of a periodically poled Lithium Niobate (PPLN) doubling crystal. Although it is feasible to operate the lasers of our invention at temperatures either slightly above or slightly below the temperature of maximum power output where the slope of the power vs. temperature curve is positive or negative, respectively, where the output power versus temperature curve is monotonic, we prefer to operate above the maximum power temperature where the slope is negative to avoid overheating of the crystal. Most preferably, the gain chip and waveguide are chosen such that the slope is negative at approximately room temperature which is a preferred operating temperature.

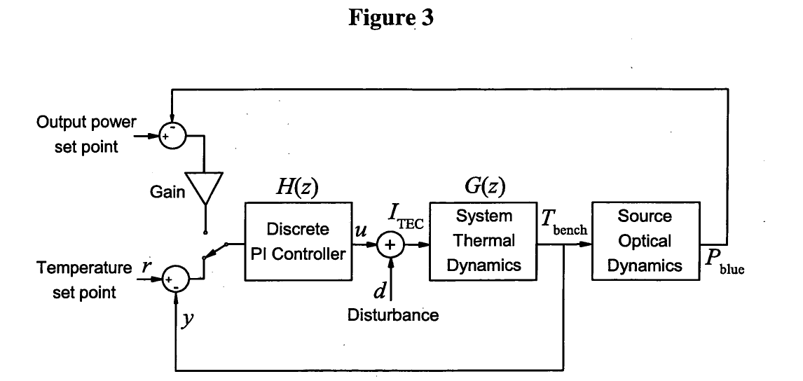

The output power of the laser is controlled by adjusting the bench temperature by varying the current to the TEC. A simplified diagram of the control loop topology is shown in FIG. 3. As may be seen, the controller may be used either to set the bench temperature or the output power to the desired value. At start-up, the temperature control loop is used to set the bench temperature slightly above the phase-matching temperature of the waveguide, so that the dependence of output power on temperature is of the same slope as the current vs. temperature curve at constant wavelength. Once the pump laser has warmed up, the loop is switched to control on the basis of the output power. Note that the power control loop remains stable only if the dependence of output power on the temperature is monotonic as shown for various wavelengths in FIG. 2b. It is thus advantageous to limit the permitted excursions of the bench temperature.

The controller for the system is preferably implemented as a discrete-time PI (proportional-integral) controller. The thermal dynamics of the system which relate the TEC current to the bench are first characterized and fitted by a linear difference equation, or equivalently by a finite-order pole-zero model with transfer function G(z). For temperature control, the controller updates the TEC current uₙ₊₁ at the n+1'st sample point in accordance with

$$\begin{matrix}{u}_{n + 1} = K ( {r}_{n} - {y}_{n} ) + {i}_{n} & ( 2 ) \\ {i}_{n} = {i}_{n - 1} + \frac{Kh}{{T}_{i}} ( {r}_{n} - {y}_{n} ) & ( 3 )\end{matrix}$$

where rₙ is the temperature set point and yₙ is the measured bench temperature. The corresponding transfer function is

$$H ( z ) = K [ \frac{1}{z} + \frac{h}{{T}_{i} ( z - 1 )} ] \qquad ( 4 )$$

where K is the proportional gain, K/Tᵢ is the integral gain and h is the sampling interval.

If we represent any disturbances to the control loop by D, which may include dissipation in the pump laser, optical heating of the waveguide etc., the closed loop transfer function for the temperature control loop is

$$Y ( z ) = \frac{G ( z ) H ( z )}{1 + G ( z ) H ( z )} R ( z ) + \frac{G ( z )}{1 + G ( z ) H ( z )} D ( z ) \qquad ( 5 )$$

The controller is primarily designed to maintain the system output near the set point despite the presence of the disturbances. The loop parameters K and Tᵢ are adjusted so that the disturbance transfer function G(z)/[1+G(z)H(z)] is small and dies away quickly without excessive oscillations. For the prototype, the disturbance transfer function decays to smaller than 2% of its peak value after 40 s.

The response of the simple PI controller to a step in the set point exhibits significant overshoot. This can be reduced by modifying (2) to
uₙ₊₁=K(brₙ−yₙ)+iₙ (6)

where b is chosen to give the best step response. With the prototype, the overshoot is less than 1%, and the settling time to within 2% of the steady-state value is 28 s.

Having obtained the loop parameters for the temperature controller, those for the output power controller are obtained by dividing the gain parameter K by the slope of the output power versus bench temperature graph shown in FIG. 2a and keeping the other parameters the same. We are able to assume that the timescale on which the bench temperature affects the output power is much faster than that of the thermal dynamics, so that the former may be considered as instantaneous for the design of the control loop.

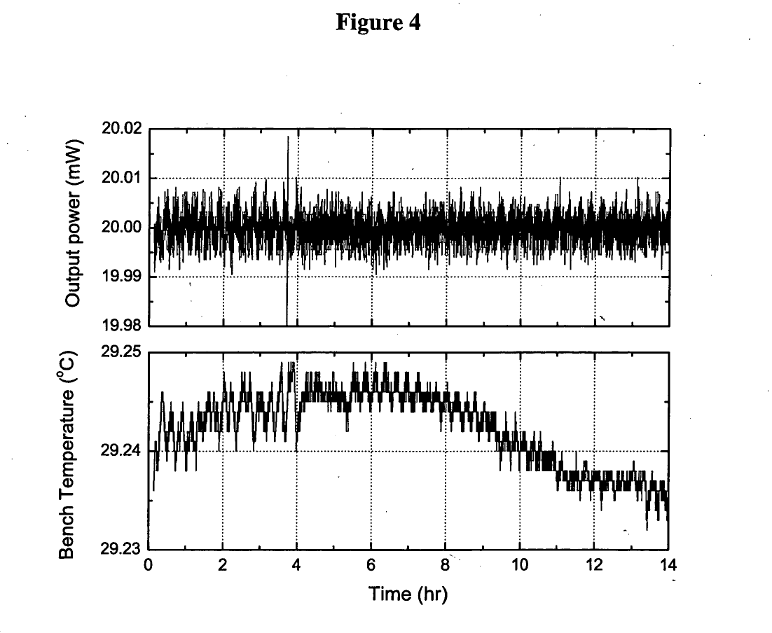

The stability of the output power and the bench temperature for one example having the output power control in operation over fourteen hours is shown in FIG. 4. The standard deviation of the output power was approximately 0.012% from its mean value and the peak-to-peak fluctuation was less than 0.1% of the mean. In practice the bench temperature may vary slowly to compensate for the diurnal temperature variation, on which are superimposed more rapid fluctuations due to, for example, the laboratory heating/air conditioning. The bench temperature was recorded by a sensor having 0.001° C. resolution, which accounts for the discrete appearance of the graph.

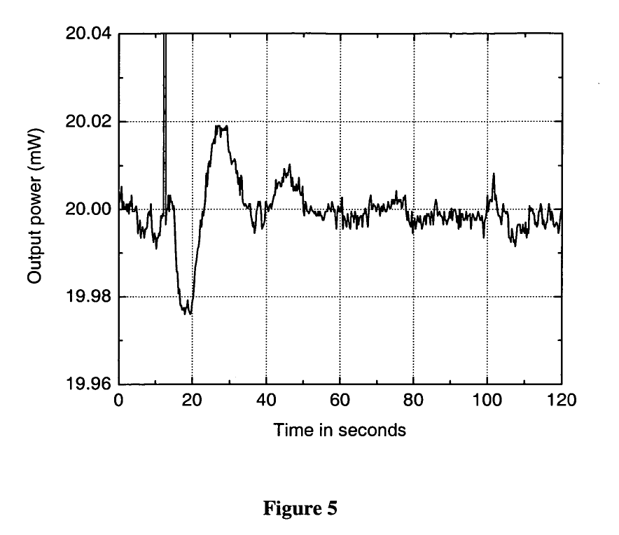

Near t=3.71 hr, a disturbance was made, which caused the output power to be incorrectly reported for a single sample. FIG. 5 shows the reaction of the output power to this transient disturbance. The overshoot and undershoot are approximately 0.1% of the mean value and the effect decays away after approximately one minute, consistent with the calculation of the disturbance response of the temperature control loop.

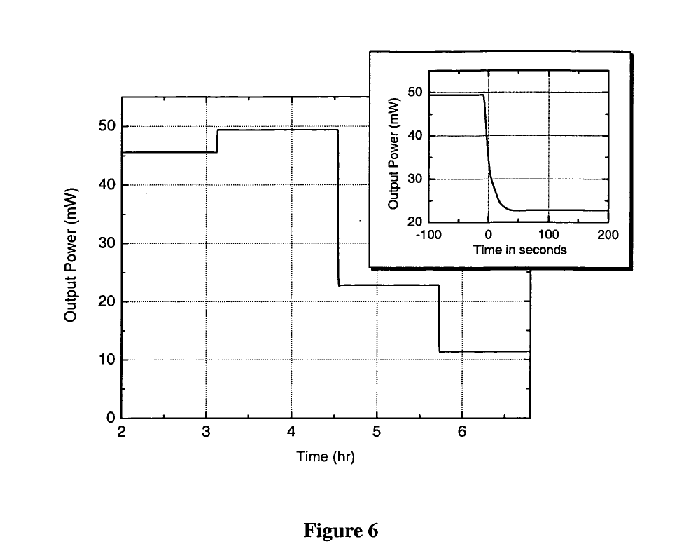

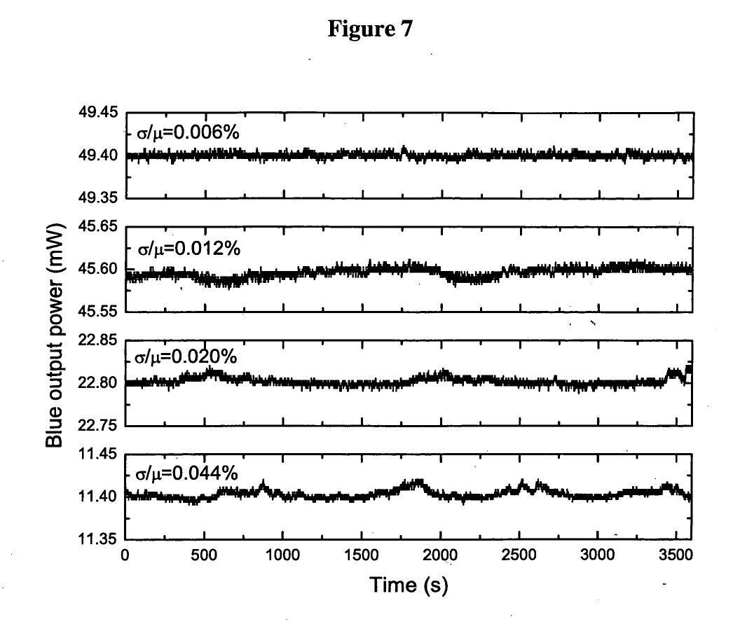

In FIG. 6, a second unit in accordance with the present invention was operated for approximately 6.8 hours with the control loop adjusted to a number of different output power set points. Each power value was maintained for more than one hour to allow power stability to be evaluated. In the overlaid graph, the power step from 49.4 mW to 22.8 mW is shown with a finer timebase. From this graph it is apparent that the source settles to its new power value in 30-60 s with minimal undershoot, also consistent with the calculated set point step response for the temperature control loop. The stability of the laser power at each of the four setpoints in FIG. 6 is shown in FIG. 7. For each graph, the ratio σ/μ denotes the ratio of the standard deviation of the power to the mean power computed over one hour. Note that the vertical span of 0.1 mW is the same for all graphs. From these, it is clear that the variation in absolute power is approximately the same, leading to a fractional variation that is approximately inversely proportional to the mean output power.

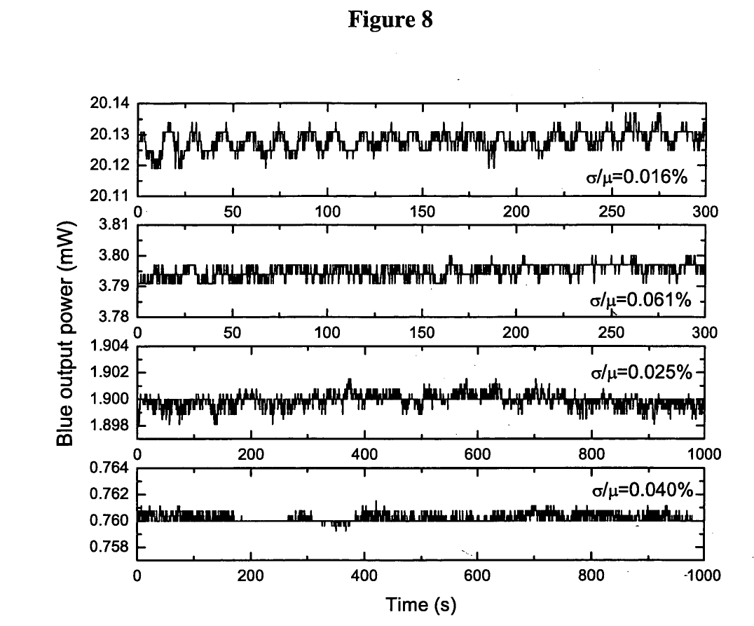

The data shown in FIG. 8 were collected for lower values of output power. The gain of the monitor photodiode was increased as indicated in the caption in order to reduce the effects of digitization noise. We see that it is possible to obtain low fractional power fluctuations over almost two orders of magnitude of output power, simply by controlling the bench temperature. Owing to the change in the slope of the graph of output power versus bench temperature (FIG. 2a) it is desirable to change the gain in the control loop as the power set point is adjusted.

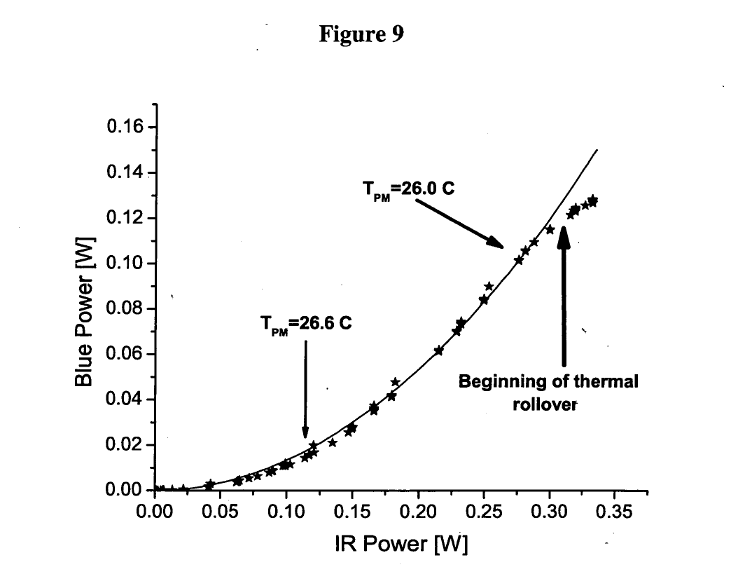

Measurements of second harmonic output power as a function of injected IR power allows us to determine the conversion efficiency of second-harmonic generation. FIG. 9 shows the dependence of generated second harmonic power on injected fundamental mode power.

The experimental data were fitted with:
Pₒᵤₜ=ξP tan h(Γ²L²), (7)

where P is input power coupled into the waveguide, ξ is its fraction coupled into TEM₀₀ mode, L is the length of the waveguide,
Γ=\sqrt{KξP} (8)

K is a combination of constants. From the data, the estimated value of the second harmonic generation efficiency is 550%/Watt. A maximum output power of about 130 mW was achieved. The experimental data match the model well, but at high injection powers some decrease of conversion efficiency becomes apparent. The most likely reason for this effect is thermal roll-over, caused by heating of the waveguide by the radiation which passes through it. In support of this hypothesis, the temperature which produces maximum output power (which is presumably close to the temperature for optimal phase matching) was found to decrease with increasing pump power at high power values. The fitting gives also an estimate of the coupling efficiency into TEM₀₀ mode of ξ=0.62.

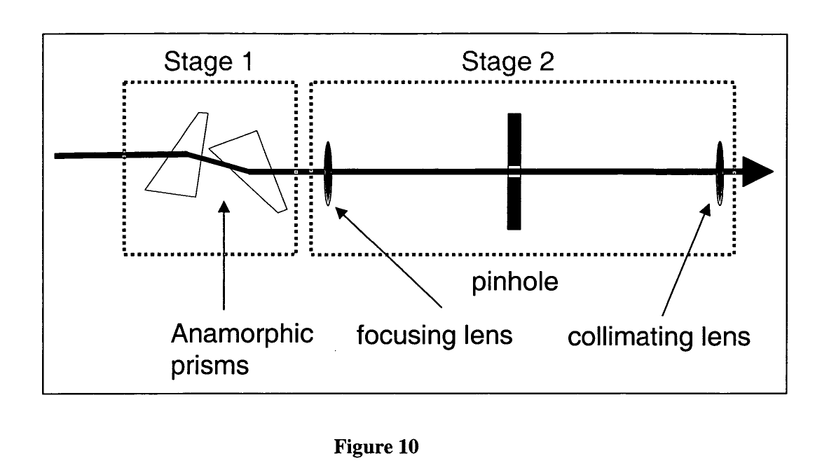

As previously discussed, the optical diagram of the laser is shown in FIGS. 1a and 1b. The second harmonic generating part consists of a pump laser and waveguide. The beam, e.g., of 488 nm wavelength, emerging from the waveguide can sometimes have substantial ellipticity and be partially contaminated by higher order modes. It is thus advantageous to apply additional beam shaping to obtain the desired beam quality. We prefer to use a two-stage beam shaping method. We first correct the emitted beam ellipticity using a pair of anamorphic prisms and then spatially filter the beam using the a pair of focusing lenses and a pinhole as shown in FIG. 10.

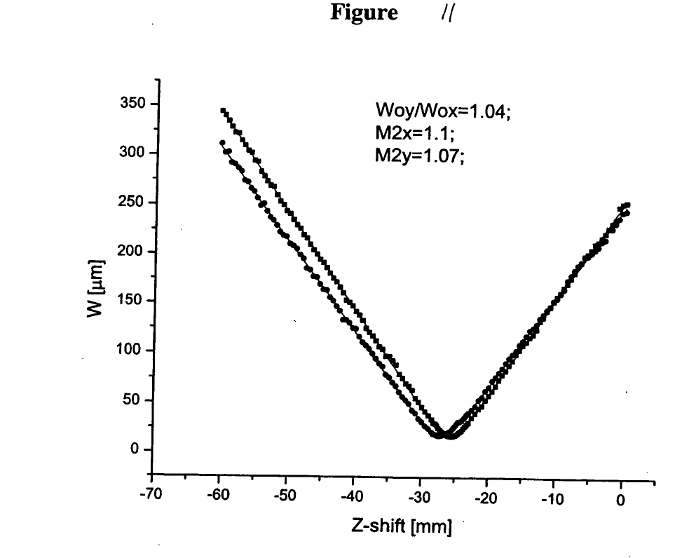

The results of beam quality measurements are shown in FIG. 11. The beam was focused with an external lens onto a “Beam Scan” profiler (Photon, Inc.). As can be seen from FIG. 11, very satisfactory beam quality has been achieved. The ellipticity is about 4% and M² does not exceed 1.1 in either direction. The beam shape does not depend on the output power, which in turn means that the beam shape is independent of the waveguide temperature. The laser did not show any traces of degradation in any of its operating characteristics, including beam quality and output power of 70 mW, during a 3.5 month period of continuous operation.

Our invention provides a new design for a simple and compact all-solid-state laser generating 300-600 nm light. The laser is preferably based on a single-frequency ECDL platform, a frequency doubling MgO:LiNbO₃ ridge waveguide and a beam shaping section. All components are mounted on a single bench. Such a layout provides high mechanical and thermal stability of the laser and simplifies its control. Temperature tuning of the bench enables the output power to be varied continuously over the range from 1 mW to over 120 mW. For example, very high power stability, with less than 0.1% peak-to-peak variation was measured during 14 hours of operation. The laser maintains a high quality TEM₀₀ circular beam with M²<1.1, and very low r.m.s. noise of less than 0.06% within the entire range of the output powers. The laser of our invention has a small footprint of approximately 5 cm×8 cm.

The foregoing detailed description of the invention includes passages that are chiefly or exclusively concerned with particular parts or aspects of the invention. It is to be understood that this is for clarity and convenience, that a particular feature may be relevant in more than just the passage in which it is disclosed, and that the disclosure herein includes all the appropriate combinations of information found in the different passages. Similarly, although the various figures and descriptions herein relate to specific embodiments of the invention, it is to be understood that where a specific feature is disclosed in the context of a particular figure or embodiment, such feature can also be used, to the extent appropriate, in the context of another figure or embodiment, in combination with another feature, or in the invention in general. Figures are schematic only and are not intended to constitute an accurate geometric portrayal of the location of the elements shown. Further, while the present invention has been particularly described in terms of certain preferred embodiments, the invention is not limited to such preferred embodiments. Rather, the scope of the invention is defined by the appended claims.

1. A laser emitting radiation having a wavelength ranging from about 300 nm to about 600 nm said laser compromising:
i) an electrically pumped pump laser emitting radiation having a wavelength ranging from about 600 nm to about 1200 nm which radiation is directed into
ii) a frequency doubling crystal waveguide, both said pump laser and said waveguide being supportably mounted on a single optical bench which bench is in thermally conductive contact with a single thermoelectric cooler.

2. A laser in accordance with claim 1 wherein said pump laser comprises an external cavity diode laser, a distributed feedback laser or a distributed Bragg Reflector laser.

3. A laser in accordance with claim 1 wherein said waveguide comprises a periodically poled crystal selected from the group consisting of Potassium Titanyl phosphate, MgO doped Lithium Niobate, and Lithium Tantalate.

4. A laser in accordance with claim 1 wherein said laser comprises a pump laser control system which maintains the output of said pump laser at a predetermined wavelength notwithstanding changes in the temperature of said optical bench.

5. A laser in accordance with claim 4 wherein the output power of said laser is a monotonic function of the temperature of said optical bench.

6. A laser in accordance with claim 5 wherein the output power of said laser is compared to a desired predetermined value and the bench temperature is adjusted to achieve said value.

7. A laser in accordance with claim 4 wherein said output power decreases monotonically when the temperature of said optical bench increases.

8. A laser in accordance with claim 4 wherein said control system controls the current to said pump laser.

9. A laser in accordance with claim 4 wherein said controller is a PID controller.

10. A laser in accordance with claim 1 wherein said gain chip and said waveguide are selected to emit frequency doubled radiation having a wavelength of 340 nm, 488 nm, 505 nm or 532 nm.

11. A laser in accordance with claim 1 wherein said optical bench is maintained at a temperature T which is above or below the phase matching temperature of said waveguide.

12. A laser in accordance with claim 11 wherein said temperature T is above the phase matching temperature of said waveguide.

13. A laser in accordance with claim 11 wherein said temperature T is approximately room temperature.

14. A laser in accordance with claim 11 wherein T is a temperature above which the conversion efficiency of said waveguide decreases with increasing T.
